(19) United States
(12) Patent Application Publication
(10) Pub. No.: US 2009/0129770 A1
(43) Pub. Date: May 21, 2009

(54) LIGHT TRANSMISSION DEVICE AND METHOD OF SETTING LIGHT INPUT BREAK DETECTION THRESHOLD VALUE

(75) Inventors: Masahiro OOHASHI, Fukuoka (JP); Yuichiro Sakane, Fukuoka (JP); Yuji Shimada, Fukuoka (JP); Hiromu Yoshii, Fukuoka (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/275,473

(22) Filed: Nov. 21, 2008

(30) Foreign Application Priority Data
Nov. 21, 2007 (JP) 2007-301758

(51) Int. Cl. H04J 14/00

(52) U.S. Cl. 398/1

(57) ABSTRACT

According to an aspect of an embodiment, in a light transmission device for switching a light transmission path for receiving an optical signal from a currently used system to a backup system when the light level of light input from a light transmission path of a currently used system becomes substantially equal to or less than a light input break detection threshold value which serves as a reference for detecting a light input break. The light transmission device includes light level measuring means for measuring the light level of the light input from the light transmission path of the currently used system, and light input break detection threshold value setting means for detecting only the light level of accumulated noise of the light level measured by the light level measuring means and setting the detected light level as the light input break detection threshold value.

### CROSS-REFERENCE TO RELATED APPLICATIONS

This application is based upon and claims the benefit of priority of the prior Japanese Application No. 2007-301758, filed on Nov. 21, 2007, the entire contents of which are incorporated herein by reference.

### BACKGROUND

1. Field

The embodiments discussed herein are related to a light transmission device and a method of setting a light input break detection threshold value for switching a light transmission path through which an optical signal is received from a currently used system to a backup system when the light level of light input from the light transmission path of the currently used system becomes substantially equal to or less than a light input break detection threshold value acting as a reference for detecting a light input break. More particularly, the embodiments relate to a light transmission device and a method of setting a light input break detection threshold value capable of automatically setting a proper light input break detection threshold value according to an accumulated amount of noise.

2. Description of the Related Art

Recently, Optical Unidirectional Path Switched Ring (OUPSR) technology is used in an optical ring network, the capacity and the distance of which are increased to realize a redundant arrangement to cope with a failure in the network.

In an optical ring network using the OUPSR technology, a light transmission device 10s on a transmission side usually transmits the same signals in both a clockwise direction and a counterclockwise direction, and a light transmission device 10r on a reception side selects either one of the directions and performs an ordinary communication as shown in FIG. 14A.

When a failure occurs in the selected direction, a reception side node detects the failure, the failure is avoided by switching to an opposite flow as shown in FIG. 14B. As to a switching time necessary to recover from such a failure, an index of 50 ms is prescribed as an index of a switching time failure recovery in the conventional SONET/SDH standard.

In the OUPSR technology, a light transmission device has a Photo Diode (PD) on both a Work side (currently used system) and a Protection side (backup system) of a reception terminal, and also has a 1×2 light switch provided forward of a light reception unit. Deterioration of a light level is monitored by the PDs on the Work side and the Protection side, and when they detect the deterioration, a light switch is switched to a non-failure side to thereby relieve an optical signal.

The light input to the PD of the reception terminal in the light transmission device ordinarily includes an optical signal and Amplified Spontaneous Emission (ASE) noise. At present, when a transmission path fails, the light transmission device sets the light level of a light input in which no optical signal is included, that is, the detectable light level of a light input which includes only ASE noise, as a light input detection threshold value. Thus, light input break detection is achieved with a fixed threshold value.

In optical networks up to now, optical signal levels were sufficiently different from ASE noise levels because the number of light amplifiers disposed in the distance from a transmission terminal to a reception terminal was restricted. Therefore, switching could be achieved by OUPSR using a fixed light input break detection threshold value. That is, heretofore, performance required for the switching time in OUPSR was sufficiently realized even with a fixed value.

In, for example, a Wavelength Division Multiplexing (WDM) transmission device, monitoring of a light level by PDs on the Work side and the Protection side, and failure information (WCF: Wavelength Channel Failure) in a unit of light channel to a downstream station obtained by detecting a light input break in an optical add drop multiplexer (OADM) are used as switching conditions of OUPSR.

WCF is transmitted up to the reception terminal by an Optical Supervisory Channel (OSC) light monitor. The light input break in the optical add and drop multiplexer is detected by a PD disposed forward of an optical multiplexer, which realizes WDM technology, in a unit of a wavelength (Per ch), or by an optical spectral analyzer (SAU: Spectrum Analyzer Unit) disposed rearward of a Wavelength Select Switch (WSS).

In addition, the technologies disclosed in, for example, Japanese Patent Application Laid-Open Publication Nos. 2006-345194 and 10-336118, are known as technologies for detecting deterioration of a light level in a light transmission device. Furthermore, there is also a light transmission device which further employs Bit Error Rate Signal Degrade (BERSD)/Bit Error Rate Signal Failure (BERSF), which is a deterioration alarm of an optical signal, as the switching condition of OUPSR.

Also, in the optical ring network described above, to increase the distance of a transmission path, light amplifiers such as an optical fiber amplifier doped with erbium (EDFA: Erbium Doped Fiber Amplifier) and the like are ordinarily disposed in the transmission path as a preamplifier (Pre AMP), an in-line amplifier (In-line AMP), and a post amplifier (Post AMP). However, recently, ASE noise, which is generated by these light amplifiers, is accumulated in an unnegligible amount in a light transmission path in which the ASE noise passes through these light amplifiers in multiple stages.

In, for example, a WDM optical network, light is generally amplified using optical fiber amplifiers doped with erbium and the like, which collectively amplify a plurality of optical signals in a wavelength range including the wavelengths of the optical signals. However, since ASE noise is generated in this light amplification, when a plurality of optical add and drop multiplexers (OADM) are connected to each other in multiple stages and used, accumulated ASE noise must be taken into consideration when a failure occurs in the network.

However, at present, the threshold value for detecting a light input break is set to a small threshold value (for example, −24 dBm) in an overall wavelength on the reception side of each unit. Accordingly, there is a case that a light input break may not be accurately detected even if a light input break actually occurs because the accumulation level of ASE noise exceeds the light input break detection threshold value due to accumulated ASE noise.

Recently, in-line amplifiers are disposed in a transmission path at given intervals and a wave division multiplex light, which is attenuated while it is transmitted, is amplified thereby so that it can be transmitted a longer distance. However, since the number of the amplifiers through which the light passes is increased by disposing the in-line amplifiers, more ASE noise is accumulated, and thus the accumulated ASE noise cannot be further ignored.

FIG. 15 is a view illustrating how ASE noise is accumulated by the in-line amplifiers disposed in multiple stages. FIG. 15 illustrates the light power (dBm) at a specific wavelength (nm). Furthermore, FIG. 15 illustrates the light powers of an optical signal and accumulation ASE noise after they pass through a first stage AMP, a second stage AMP, and third stage AMP from the left. Furthermore, the top graphs illustrate a case where a light input signal is present, and the lower graphs illustrate a case where no light input signal is present.

As shown in FIG. 15, as the number of the in-line amplifiers through which the light passes increases, more ASE noise is accumulated; and since the accumulated ASE noise (for example, −22 dBm) exceeds the light input break detection threshold value (for example, −24 dBm), a light input break cannot be detected even in the state that a light input signal is not present.

In contrast, when WCF is used as the switching condition of OUPSR in addition to the detection of a light input break, since the number of pass-through stations is increased due to the sweep speed of a spectral analyzer and the increase of a distance, a transmission time as well as a processing time in a device are delayed. Thus, a problem also arises in that a prescribed switching time cannot be satisfied.

### SUMMARY

According to an aspect of an embodiment, in a light transmission device for switching a light transmission path for receiving an optical signal from a currently used system to a backup system when the light level of light input from a light transmission path of a currently used system becomes substantially equal to or less than a light input break detection threshold value which serves as a reference for detecting a light input break. The light transmission device includes light level measuring means for measuring the light level of the light input from the light transmission path of the currently used system, and light input break detection threshold value setting means for detecting only the light level of accumulated noise of the light level measured by the light level measuring means and setting the detected light level as the light input break detection threshold value.

Additional objects and advantages of the embodiment will be set forth in part in the description which follows, and in part will be obvious from the description, or may be learned by practice of the embodiment. The object and advantages of the embodiment will be realized and attained by means of the elements and combinations particularly pointed out in the appended claims.

It is to be understood that both the foregoing general description and the following detailed description are exemplary and explanatory only and are not restrictive of the embodiment, as claimed.

### BRIEF DESCRIPTION OF THE DRAWINGS

FIG. 1 is a function block diagram illustrating a configuration of a WDM device to which the present invention is applied;

FIG. 2 is a view illustrating a transmission device and a reception device according to Embodiment 1;

FIG. 3 is a flowchart illustrating a processing procedure of a transmission device and a reception device according to Embodiment 1;

FIG. 4 is a view illustrating a transmission device and a reception device according to Embodiment 2;

FIG. 5 is a view illustrating a cut of an optical signal band performed by a band-pass filter;

FIG. 6 is a view illustrating a transmission device and a reception device according to Embodiment 3;

FIG. 7 is an explanatory view explaining OSNR;

FIG. 8 is a view illustrating a transmission device and a reception device according to Embodiment 4;

FIG. 9 is a view illustrating a transmission device and a reception device according to Embodiment 5;

FIG. 10 is a view illustrating a transmission device and a reception device according to Embodiment 6;

FIG. 11 is a view illustrating a transmission device and a reception device according to Embodiment 7;

FIG. 12 is a view illustrating a transmission device and a reception device according to Embodiment 8;

FIG. 13 is a function block diagram illustrating a configuration of a computer for executing a light input break detection threshold value setting program according to Embodiment 8;

FIG. 14A is an explanatory view explaining OUPSR technology at ordinary time;

FIG. 14B is an explanatory view explaining OUPSR technology when a failure occurs; and

FIG. 15 is a view illustrating ASE noise accumulated by in-line amplifiers disposed in multiple stages.

### DETAILED DESCRIPTION OF THE PREFERRED EMBODIMENTS

According to the embodiment, since the light level of light input from a light transmission path of a currently used system is measured, only the light level of accumulated noise of the measured light level is detected, and the detected light level is set as a light input break detection threshold value, there can be achieved an advantage that a proper light input section detecting threshold value can be automatically set according to the accumulated amount of noise.

Furthermore, according to the embodiment, the measured light level is set as the light input break detection threshold value after a light shutdown notification, which requests to stop output of an optical signal, is transmitted to a light transmission device of a source connected through a light transmission path of a currently used system, and the light transmission device of the source stops the output of the optical signal. Therefore, there can be achieved an advantage that a proper light input break detection threshold value can be automatically set easily.

According to the embodiment, the band in which the optical signal is included is deleted from the band of light input from the light transmission path of the currently used system, and the light level of only the accumulated noise, from which the band of the optical signal is deleted, is measured, and the measured light level is set as the light input break detection threshold value. Therefore, there can be achieved an advantage that a proper light input break detection threshold value can be effectively set making use of an existing band-pass filter and the like.

According to the embodiment, the optical signal to noise ratio of the light input from the light transmission path of the currently used system is measured, and the light level of only the accumulated noise is calculated based on the measured optical signal to noise ratio, and the calculated light level is set as a light input break detection threshold value. Therefore, there can be achieved an advantage that a proper light input break detection threshold value can be automatically set effectively.

According to the embodiment, the number of stages of light amplifiers disposed on the light transmission path of the currently used system is totaled, and the light level of only the accumulated noise is calculated based on the totaled number of stages of the totaled light amplifiers, and the calculated light level is set as the light input break detection threshold value. Therefore, there can be achieved an advantage that a proper light input break detection threshold value can be automatically set according to the number of stages of the light amplifiers.

Furthermore, according to the embodiment, since the light level of noise, which is actually generated in the respective light amplifiers disposed in the light transmission path of the currently used system in multiple stages, is totaled, and the totaled light level is set as the light input break detection threshold value, there can be achieved an advantage that the proper light input break detection threshold value can be automatically set more accurately.

Preferable embodiments of a light transmission device, a method of setting a light input break detection threshold value, and a light input break detection threshold value setting program according to the present invention will be explained below in detail referring to the accompanying drawings. Note that, the present embodiment will mainly explain the case that the present invention is applied to a WDM transmission device in which OUPSR technology is used.

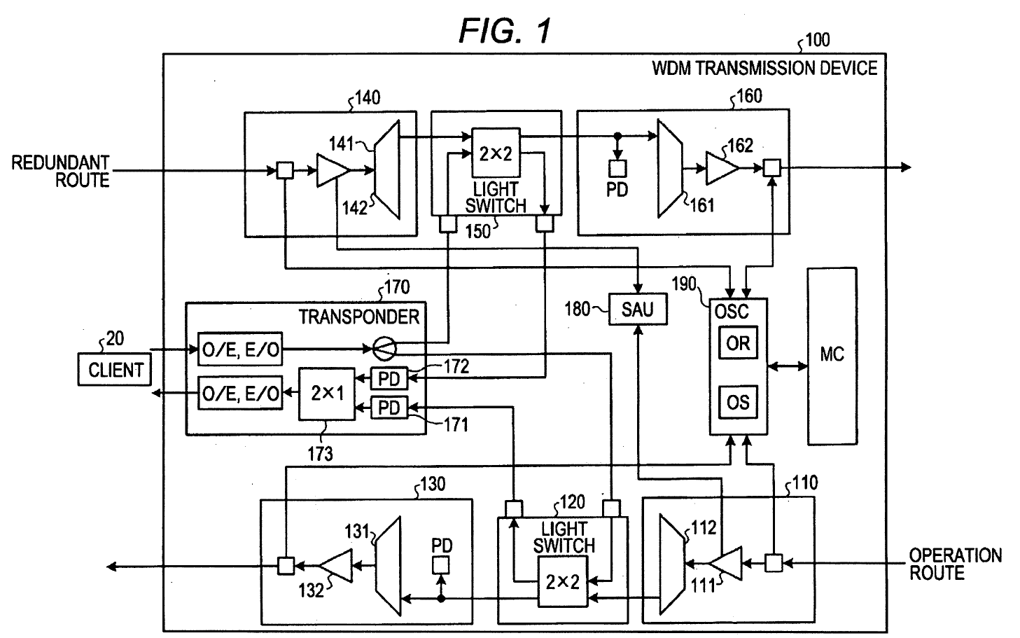

First, a configuration of the WDM device to which the present invention is applied will be explained. FIG. 1 is a function block diagram illustrating the configuration of the WDM device to which the present invention is applied. As shown in FIG. 1, the WDM transmission device 100 is connected to an optical ring network, in which the OUPSR technology is used, through an operation route as a light transmission path of a currently used system and an operation route as a light transmission path of a backup system, and is connected to a client's device (Client) 20 through an optical network.

Furthermore, the WDM transmission device 100 has an optical signal reception unit 110, a light switch 120, an optical signal transmission unit 130, an optical signal reception unit 140, a light switch 150, an optical signal transmission unit 160, a transponder 170, an SAU 180, and an OSC 190 as main function units.

The optical signal reception unit 110 amplifies an optical signal input from an input side operation route by a preamplifier 111, demultiplexes the amplified optical signal into a unit of wavelength by an optical demultiplexer 112, and inputs the demultiplexed optical signals to the light switch 120.

The light switch 120 inputs the optical signals, which are demultiplexed into the unit of wavelength by the optical signal reception unit 110 to a transponder 170 corresponding to each wavelength, and further inputs an optical signal input from each transponder 170 to the optical signal transmission unit 130.

The optical signal transmission unit 130 multiplexes optical signals input from the light switch 120 by an optical multiplexer 131, amplifies a multiplexed optical signal by a post amplifier 132, and outputs it to an output side operation route.

The optical signal reception unit 140 amplifies an optical signal input from an input side redundant route by a preamplifier 141, demultiplexes the amplified optical signal into a unit of wavelength by an optical demultiplexer 142, and inputs demultiplexed optical signals to the light switch 150.

The light switch 150 inputs the optical signals demultiplexed into the unit of wavelength by the optical signal reception unit 140 to a transponder 170 corresponding to each wavelength and further inputs an optical signal input from each transponder 170 to the optical signal transmission unit 160.

The optical signal transmission unit 160 multiplexes optical signals input from the light switch 150 by an optical multiplexer 161, amplifies a multiplexed optical signal by a post amplifier 162, and then outputs it to the output side operation route.

After the transponder 170 converts a client signal transmitted from the client's device 20 into an electric signal, the transponder 170 converts the electric signal into the optical signal again after it codes the electric signal by a given coding system, and inputs the converted optical signal to both the light switches 120 and 150.

Furthermore, the transponder 170 has a Photo Diode (PD) 171 for detecting light input from the light switch 120 and a PD 172 for detecting light input from the light switch 150. Although an optical signal is ordinarily input from the light switch 120 on the operation route side, when light detected by the PD 171, that is, the light level of light input from an operation route, becomes equal to or less than the light input section detecting threshold value, a light switch 173 switches the input source of the optical signal to the light switch 150 on a redundant route side. Note that “the light input break detection threshold value” used here is a threshold value which serves as a reference for detecting whether or not light input from the operation route is shut down due to a failure and the like.

When the optical signal is input from the light switch 120 or 150, the transponder 170 codes the optical signal by the given coding system, converts a coded optical signal into the optical signal again, and transmits a converted optical signal to the client's device 20.

Note that although a plurality of transponders are actually disposed in the unit of wavelength of the optical signal as the transponder 170 explained here, illustration thereof is omitted to simplify the explanation.

The SAU 180 is a processing unit for measuring the spectral waveform of light input from the operation route and the redundant route in the unit of wavelength. The OSC 190 is a processing unit for monitoring light that is input and output through the operation route and through the redundant route.

The WDM transmission device 100 to which the present invention is applied is explained as described above. In the present invention, the WDM transmission device 100 described above measures the light level of the light input from the operation route, detects only the light level of accumulated noise of the measured light level, and sets the detected light level as the light input break detection threshold value. As a result, a proper light input break detecting threshold value can be automatically set according to the accumulated amount of ASE noise.

Embodiments 1 to 8 of the present invention will be specifically explained below. Note that, in the following description, attention is paid to the correlation between a transmission side WDM transmission device (hereinafter, called “transmission device”) and a reception side WDM transmission device (hereinafter, called “reception device”) in an operation route, and configuration and process flows of the respective devices will be explained.

### Embodiment 1

First, Embodiment 1 will be explained. In Embodiment 1, a reception device transmits a light shutdown notification to a transmission device connected thereto through an operation route to request it to stop outputting an optical signal. After the transmission device stops outputting the optical signal in response to the light shutdown notification transmitted thereof, the reception device sets a measured light level as a light input break detection threshold value.

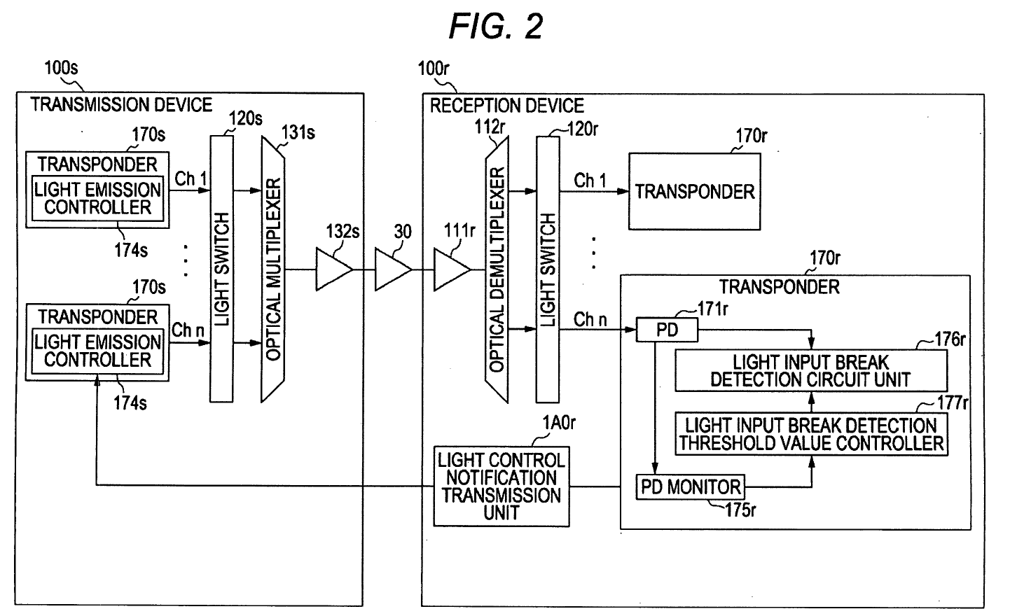

FIG. 2 is a view illustrating the transmission device and the reception device according to Embodiment 1. Note that, to simplify the explanation, only the function units that are necessary to explain the feature of Embodiment 1 will be explained here. Also, the function units which achieve the same roles as those of the respective function units shown in FIG. 1 are denoted by the same reference numerals (“s” is added to the reference numerals on the transmission device side, and “r” is added to the reference numerals on the reception device side) and the detailed explanation thereof is omitted.

As shown in FIG. 2, the transmission device 100s and the reception device 100r according to Embodiment 1 are connected to each other through an optical ring network to which an in-line amplifier is disposed. Note that although only one in-line amplifier 30 is shown here, a plurality of in-line amplifiers 30 are actually disposed in multiple stages on the optical ring network.

The transmission device 100s has a light switch 120s, an optical multiplexer 131s, a post amplifier 132s, and transponders 170s disposed to respective wavelengths (Ch 1 to Ch n). In contrast, the reception device 100r has a preamplifier 111r, an optical demultiplexer 112r, a light switch 120r, and transponders 170r disposed to the respective wavelengths (Ch 1 to Ch n).

Furthermore, each of the transponders 170s of the transmission device 100s has a light emission controller 174s, and each of the transponders 170r of the reception device 100r has a PD 171r, a PD monitor 175r, a light input break detection circuit unit 176r, a light input break detection threshold value controller 177r, and a light control notification transmission unit 1A0r.

Here, an optical signal is input from the transponder 170s of the transmission device 100s, sequentially passes through the light switch 120s, the optical multiplexer 131s, and the post amplifier 132s, is transmitted through the in-line amplifier 30, sequentially passes through the preamplifier 111r, the optical demultiplexer 112r, and the light switch 120r in the reception device 100r, and is input to the transponder 170r.

In the transmission device 100s, the light emission controller 174s of each transponder 170s is a processing unit for controlling output of the optical signal transmitted to the reception device 100r. Specifically, when the light emission controller 174s receives a light shutdown notification to be described below from the reception device 100r, it stops outputting the optical signal transmitted to the reception device 100r. Furthermore, when the light emission controller 174s receives a light emission notification to be described below from the reception device 100r, it starts to output the optical signal transmitted to the reception device 100r.

In the reception device 100r, the light control notification transmission unit 1A0r is a processing unit for notifying an instruction relating to the output of the optical signal to the transmission device 100s connected thereto through an operation route. Specifically, when an operator inputs a threshold value setting command to the light control notification transmission unit 1A0r through a input means (not shown) such as a keyboard, mouse, and the like, the light control notification transmission unit 1A0r transmits a light shutdown notification to the transmission device 100s to request it to stop outputting the optical signal.

Furthermore, when the light input break detection threshold value is set by the light input break detection threshold value controller 177r to be described below, the light control notification transmission unit 1A0r transmits a light emission notification to the transmission device 100s to request it to start to output the optical signal.

The PD monitor 175r of each transponder 170r is a processing unit for measuring the light level of light detected by the PD 171r.

The light input break detection circuit unit 176r is a processing unit for detecting the input break of light transmitted from the transmission device 100s through the operation route. Specifically, the light input break detection circuit unit 176r ordinarily inputs the optical signal from the light switch 120r located on the operation route side. However, when the light detected by the PD 171, that is, the light level of the light input from the operation route, becomes substantially equal to or less than the light input break detecting threshold value, the light input break detection circuit unit 176r controls a light switch 173r (not shown) and switches an input source of the optical signal to a light switch 150r (not shown) located on a redundant route side.

The light input break detection threshold value controller 177r is a processing unit for setting the light level of accumulated noise as the light input break detection threshold value. Specifically, after the transmission device 100s stops outputting the optical signal in response to the shutdown notification transmitted by the light control notification transmission unit 1A0r, the light input break detection threshold value controller 177r sets the light level measured by the PD monitor 175r as the light input break detection threshold value which serves as a reference of a light input break performed by the light input break detection circuit unit 176r.

Ordinarily, the light, which is input from the operation route and detected by the PD 171r, includes not only the optical signal transmitted by the transmission device 100s but also the accumulation of ASE noise (accumulated noise) generated by the plurality of in-line amplifiers 30 disposed in multiple stages in the optical ring network. However, after the output of the optical signal is stopped by the transmission device 100s, the light level measured by the PD monitor 175r is only the light level of the accumulated noise.

Accordingly, the light input break detection threshold value, which is set by the light input break detection threshold value controller 177r after the output of the optical signal is stopped by the transmission device 100s, is the light level of only the accumulated noise from which the light level of the optical signal is removed.

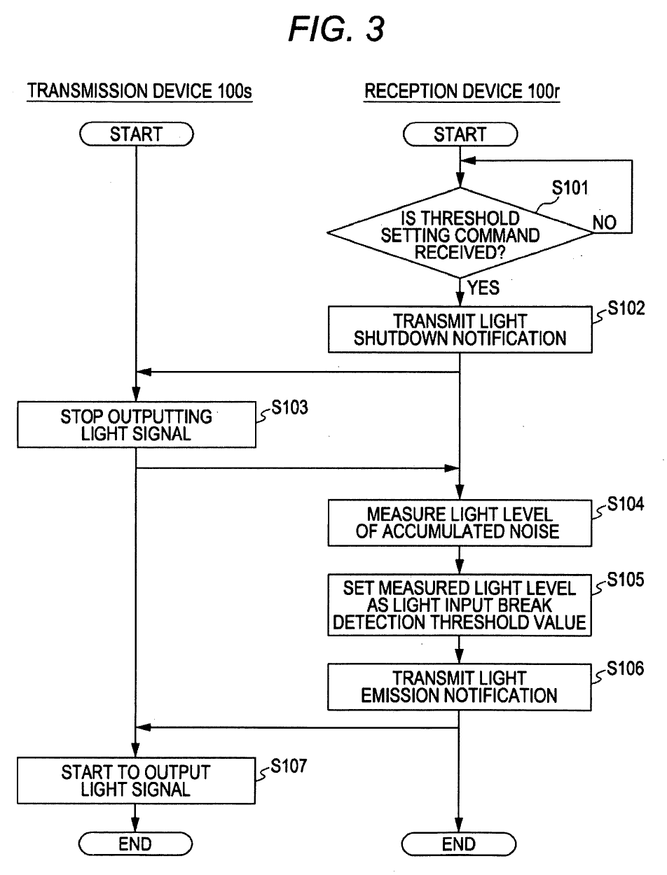

Subsequently, processing procedures of the transmission device 100s and the reception device 100r according to Embodiment 1 will be explained. FIG. 3 is a flowchart illustrating the processing procedures of the transmission device 100s and the reception device 100r according to Embodiment 1.

As shown in FIG. 3, in the reception device 100r of Embodiment 1, when the light control notification transmission unit 1A0r receives the threshold value setting command from the operator (step S101), the reception device 100r transmits the light shutdown notification to the transmission device 100s to request it to stop outputting the optical signal (step S102).

Then the light emission controller 174s of the transmission device 100s, which receives the light shutdown notification, stops outputting the optical signal (step S103).

Thereafter, the PD monitor 175r of the reception device 100r measures the light level of the accumulated noise (step S104), and the light input break detection threshold value controller 177r sets the light level measured by the PD monitor 175r as the light input break detection threshold value which serves as the reference for detecting the light input break (step S105).

When the light input break detection threshold value is set by the light input break detection threshold value controller 177r, the light control notification transmission unit 1A0r transmits the light emission notification to the transmission device 100s to request it to start to output the optical signal (step S106).

Then, the light emission controller 174s of the transmission device 100s which receives the light emission notification starts to output the optical signal (step S107).

As described above, in the reception device 100r of Embodiment 1, the light control notification transmission unit 1A0r transmits the light shutdown notification to the transmission device 100s connected thereto through the operation route to request it to stop outputting the optical signal, and the light input break detection threshold value controller 177r sets the light level measured by the PD monitor 175r as the light input break detection threshold value after the transmission device 100s stops outputting the optical signal in response to the shutdown notification transmitted by the light control notification transmission unit 1A0r. As a result, a proper light input break detection threshold value can be automatically set according to the accumulated amount of ASE noise. Furthermore, since the reception device 100r can measure the light level of the accumulated noise merely by causing the transmission device 100s to stop outputting the optical signal, a proper light input break detection threshold value can be set easily by suppressing the amount of improvement of the processing units as to reception of light.

### Embodiment 2

Next, Embodiment 2 will be explained. In Embodiment 2, a reception device removes the band, in which an optical signal is included, from the band of light input from an operation route, measures the light level of only accumulated noise from which the band of the optical signal is removed, and sets the measured light level as a light input break detection threshold value.

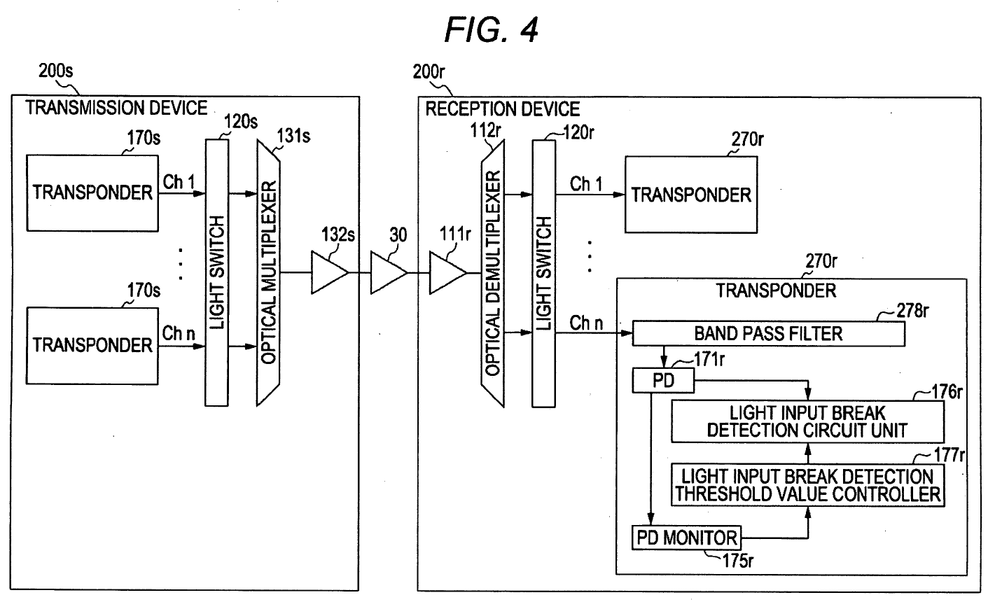

FIG. 4 is a view illustrating a transmission device and the reception device according to Embodiment 2. Note that, to simplify the explanation, only the function units that are necessary to explain the feature of Embodiment 2 will be explained here. Also, the function units that achieve the same roles as those of the respective function units described up to now are denoted by the same reference numerals, and the detailed explanation thereof is omitted.

As shown in FIG. 4, a transmission device 200s and a reception device 200r according to Embodiment 2 are connected to each other through an optical ring network in which an in-line amplifier is disposed. Note that, although only one in-line amplifier 30 is shown here, a plurality of in-line amplifiers 30 is disposed in multiple stages on the optical ring network.

The transmission device 200s has a light switch 120s, an optical multiplexer 131s, a post amplifier 132s, and transponders 170s disposed to respective wavelengths (Ch 1 to Ch n). In contrast, the reception device 200r has a preamplifier 111r, an optical demultiplexer 112r, a light switch 120r, and transponders 270r disposed to respective wavelengths (Ch 1 to Ch n).

Furthermore, the respective transponders 270r of the reception device 200r has a PD 171r, a PD monitor 175r, a light input break detection circuit unit 176r, a light input break detection threshold value controller 177r, and a band-pass filter unit 278r.

Here, the optical signal is input from the transponders 170s of the transmission device 200s, sequentially passes through the light switch 120s, the optical multiplexer 131s, and the post amplifier 132s, is transmitted through the in-line amplifier 30, sequentially passes through the preamplifier 111r, the optical demultiplexer 112r, and the light switch 120r in the reception device 200r, and input to the transponders 270r.

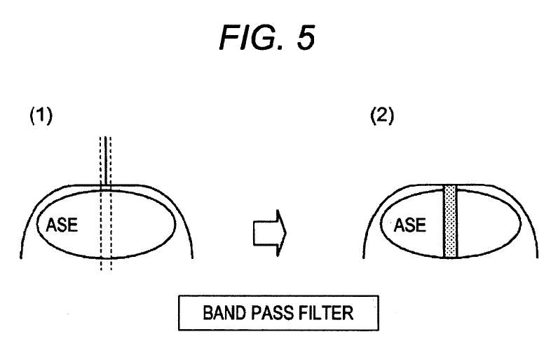

In the reception device 200r, the band-pass filter unit 278r included in the transponder 270r is a processing unit for cutting the band, in which the optical signal is included, from the band of light input from the operation route. FIG. 5 is a view illustrating the cut of the optical signal band performed by the band-pass filter unit 278r. As shown in FIG. 5, the band-pass filter unit 278r cuts the band (band between the dotted lines in part (1) of the drawing), in which the optical signal is included, from the band of light input from the operation route using a given band-pass filter.

The light, from which the band of the optical signal is cut, is input in the PD 171r, and the light level thereof is measured by the PD monitor 175r. Accordingly, the light level measured here is the light level of only the accumulated noise in which the optical signal is not included. Then, the measured light level of the accumulated noise is set as the light input break detection threshold value by the light input break detection threshold value controller 177r.

Note that, as shown in FIG. 5, although the band-pass filter unit 278r cuts the optical signal component and the ASE noise component of the band of the optical signal (shaded portion shown in part (2) of FIG. 5) by the band-pass filter, since the band is a narrow band, it does not affect the accumulated amount of ASE noise.

As described above, in the reception device 200r of Embodiment 2, the band-pass filter unit 278r cuts the band, in which the optical signal is included, from the band of the light input from the operation route, the PD monitor 175r measures the light level of only the accumulated noise from which the band of the optical signal is cut by the band-pass filter unit 278r, and the light input break detection threshold value controller 177r sets the light level measured by the PD monitor 175r as the light input break detection threshold value. As a result, a proper light input break detection threshold value can be automatically set according to the accumulated amount of ASE noise. Furthermore, a proper light input break detection threshold value can be effectively set using an existing band-pass filter and the like.

### Embodiment 3

Next, Embodiment 3 will be explained. In Embodiment 3, a reception device measures the optical signal to noise ratio of light input from an operation route, calculates only the light level of only accumulated noise based on the measured optical signal to noise ratio, and sets the calculated light level as a light input break detection threshold value.

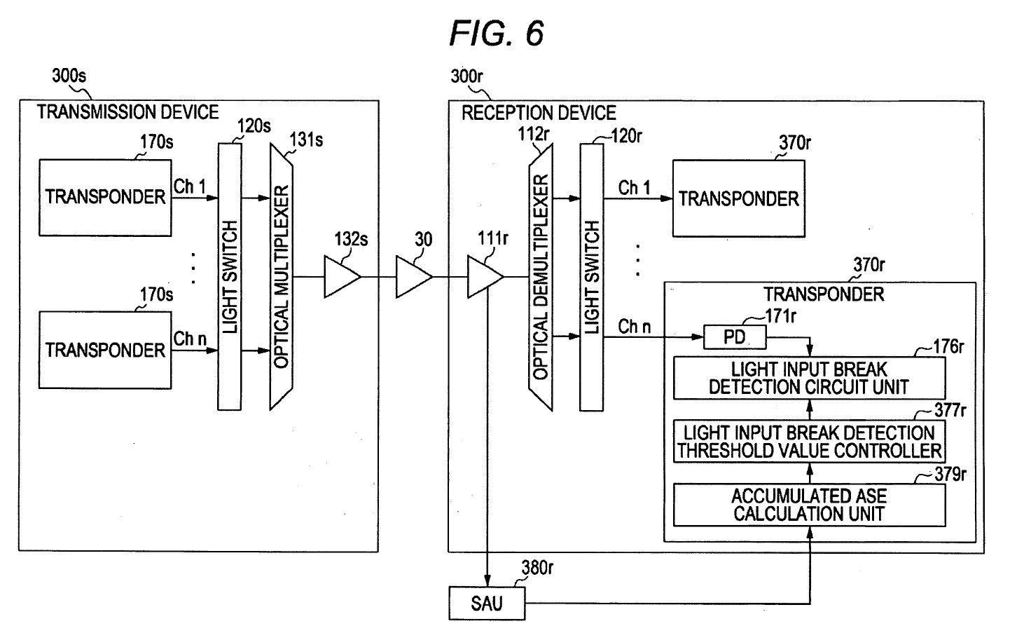

FIG. 6 is a view illustrating a transmission device and the reception device according to Embodiment 3. Note that, to simplify the explanation, only the function units that are necessary to explain the feature of Embodiment 3 will be shown here. Also, the function units that achieve the same roles as those of the respective function units shown up to now are denoted by the same reference numerals, and the detailed explanation thereof is omitted.

As shown in FIG. 6, a transmission device 300s and a reception device 300r according to Embodiment 3 are connected to each other through an optical ring network in which an in-line amplifier is disposed. Note that although only one in-line amplifier 30 is illustrated here, a plurality of in-line amplifiers 30 is actually disposed in multiple stages on the optical ring network.

The transmission device 300s has a light switch 120s, an optical multiplexer 131s, a post amplifier 132s, and transponders 170s disposed to respective wavelengths (Ch 1 to Ch n). In contrast, the reception device 300r has a preamplifier 111r, an optical demultiplexer 112r, a light switch 120r, transponders 370r disposed to the respective wavelengths (Ch 1 to Ch n), and an SAU 380r.

Furthermore, each of the transponders 370r of the reception device 300r has a PD 171r, a light input break detection circuit unit 176r, a light input break detection threshold value controller 377r, and an accumulated ASE calculation unit 379r.

Here, an optical signal is input from the transponders 170s of the transmission device 300s, sequentially passes through the light switch 120s, the optical multiplexer 131s, and the post amplifier 132s, is transmitted through the in-line amplifier 30, sequentially passes through the preamplifier 111r, the optical demultiplexer 112r, and the light switch 120r in the reception device 300r, and is input to the transponders 370r.

In the reception device 300r, the SAU 380r is a processing unit that is connected to the preamplifier 111r and measures the spectral waveform of light input from the operation route and a redundant route in a unit of wavelength. The SAU 380r measures the Optical Signal to Noise Ratio (OSNR) of light input from the operation route based on the measured spectral waveform.

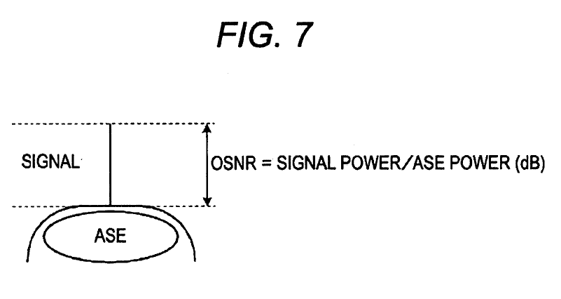

FIG. 7 is an explanatory view for explaining the OSNR. As shown in FIG. 7, the OSNR is the logarithmic ratio of an amount of noise (ASE power) to an optical signal (Signal Power), and is expressed by dB (decibel). That is, an optical signal of higher quality with a less amount of noise can be obtained from a larger numerical value of the OSNR.

Furthermore, the accumulated ASE calculation unit 379r of each transponder 370r is a processing unit for calculating the light level of only accumulated noise based on the OSNR measured by the SAU 380r

The light input break detection threshold value controller 377r is a processing unit for setting the light level of the accumulated noise as a light input break detection threshold value. Specifically, the light input break detection threshold value controller 377r sets the light level of the accumulated noise calculated by the accumulated ASE calculation unit 379r as the light input break detection threshold value which serves as a reference of a light input break performed by the light input break detection circuit unit 176r.

As described above, in the reception device 300r of Embodiment 3, the SAU 380r measures the OSNR of the light input from the operation route, the accumulated ASE calculation unit 379r calculates the light level of only the accumulated noise based on the OSNR measured by the SAU 380r, and the light input break detection threshold value controller 377r sets the light level calculated by the accumulated ASE calculation unit 379r as the light input break detection threshold value. As a result, a proper light input break detection threshold value can be automatically set according to the accumulated amount of ASE noise. Since the light level of the accumulated noise is calculated by the OSNR, a proper input break detection threshold value can be effectively set.

### Embodiment 4

Next, Embodiment 4 will be explained. In Embodiment 4, a reception device transmits a light shutdown notification to a transmission device connected thereto through an operation route to request it to stop outputting an optical signal and sets a measured light level as a light input break detection threshold value after the transmission device stops outputting the optical signal in response to the light shutdown notification transmitted thereto like Embodiment 1. However, Embodiment 4 is different from Embodiment 1 in that it uses an SAU.

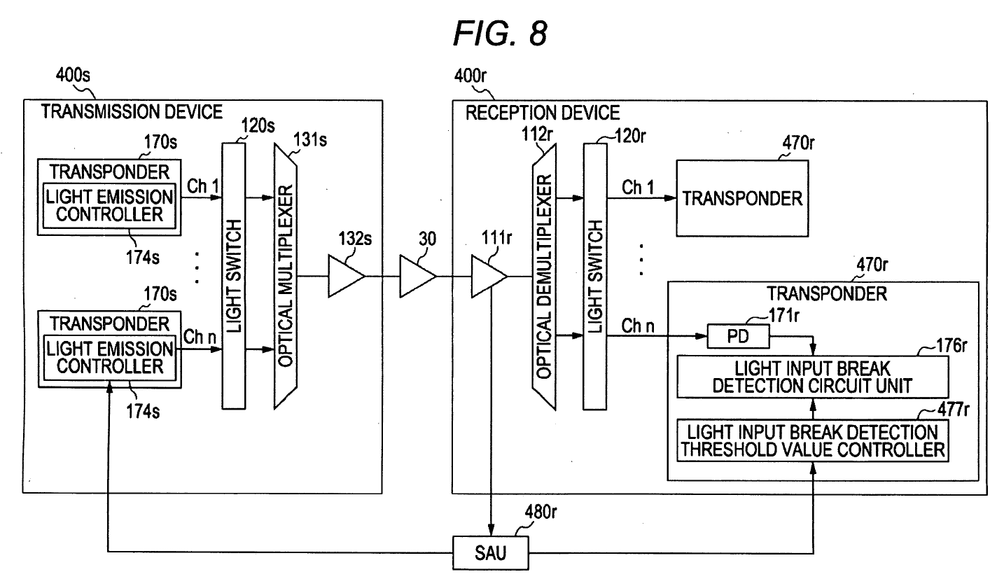

FIG. 8 is a view illustrating the transmission device and the reception device according to Embodiment 4. Note that, to simplify the explanation, only function units that are necessary to explain the feature of Embodiment 4 will be explained here. Also, the function units that achieve the same roles as those of the respective function units shown up to now are denoted by the same reference numerals, and the detailed explanation thereof is omitted.

As shown in FIG. 8, a transmission device 400s and a reception device 400r according to Embodiment 4 are connected to each other through an optical ring network in which an in-line amplifier is disposed. Note that although only one in-line amplifier 30 is shown here, a plurality of in-line amplifiers 30 is actually disposed in multiple stages on the optical ring network.

The transmission device 400s has a light switch 120s, an optical multiplexer 131s, a post amplifier 132s, and transponders 170s disposed to respective wavelengths (Ch 1 to Ch n). In contrast, the reception device 400r has a preamplifier 111r, an optical demultiplexer 112r, a light switch 120r, transponders 470r disposed to the respective wavelengths (Ch 1 to Ch n), and an SAU 480r.

Furthermore, each of the transponders 170s of the transmission device 400s has a light emission controller 174s, and each of the transponders 470r of the reception device 400r has a PD 171r, a light input break detection circuit unit 176r, and a light input break detection threshold value controller 477r.

Here, the optical signal is input from the transponders 170s of the transmission device 400s, sequentially passes through the light switch 120s, the optical multiplexer 131s, and the post amplifier 132s, is transmitted through the in-line amplifier 30, sequentially passes through the preamplifier 111r, the optical demultiplexer 112r, and the light switch 120r in the reception device 400r, and is input to the transponders 470r.

In the reception device 400r, the SAU 480r is a processing unit that is connected to the preamplifier 111r and measures the spectral waveform of light input from the operation route and a redundant route in a unit of wavelength. When an operator inputs a threshold setting command through an input means (not shown), such as keyboard, mouse, and the like, the SAU 480r transmits a light shutdown notification to the transmission device 400s to request it to stop outputting the optical signal.

Then, after the transmission device 400s stops outputting the optical signal in response to the light shutdown notification transmitted thereto, the SAU 480r measures a light level based on the measured spectral waveform and reports the measured light level of the optical signal to the light input break detection threshold value controller 477r. Accordingly, the light input break detection threshold value reported by the SAU 480r is the light level of only accumulated noise from which the light level of the optical signal is removed.

Furthermore, when the light input break detection threshold value is set by the light input break detection threshold value controller 477r to be described below, the SAU 480r transmits a light emission notification to the transmission device 400s to request it to start to output the optical signal.

The light input break detection threshold value controller 477r is a processing unit for setting the light level of accumulated noise as the light input break detection threshold value. Specifically, the light input break detection threshold value controller 477r sets the light level of the accumulated noise reported from the SAU 480r as the light input break detection threshold value which serves as a reference of a light input break performed by the light input break detection circuit unit 176r

As described above, in the reception device 400r of Embodiment 4, the SAU 480r transmits the light shutdown notification to the transmission device 400s connected thereto through the operation route to request it to stop outputting the optical signal, and the light input break detection threshold value controller 477r sets the light level measured by the SAU 480r as the light input break detection threshold value after the transmission device 400s stops outputting the optical signal in response to the light shutdown notification transmitted by the SAU 480r. As a result, a proper light input break detection threshold value can be automatically set according to the accumulated amount of ASE noise. Furthermore, since the SAU, which has the function of measuring the light level, has already been used, a proper light input break detection threshold value can be set easily.

### Embodiment 5

Next, Embodiment 5 will be explained. In Embodiment 5, a reception device removes the band, in which an optical signal is included, from the band of light input from an operation route. The reception device measures the light level of only accumulated noise from which the band of the optical signal is removed, and sets a measured light level as a light input break detection threshold value like Embodiment 2. However, Embodiment 5 is different from Embodiment 2 in that it uses an SAU.

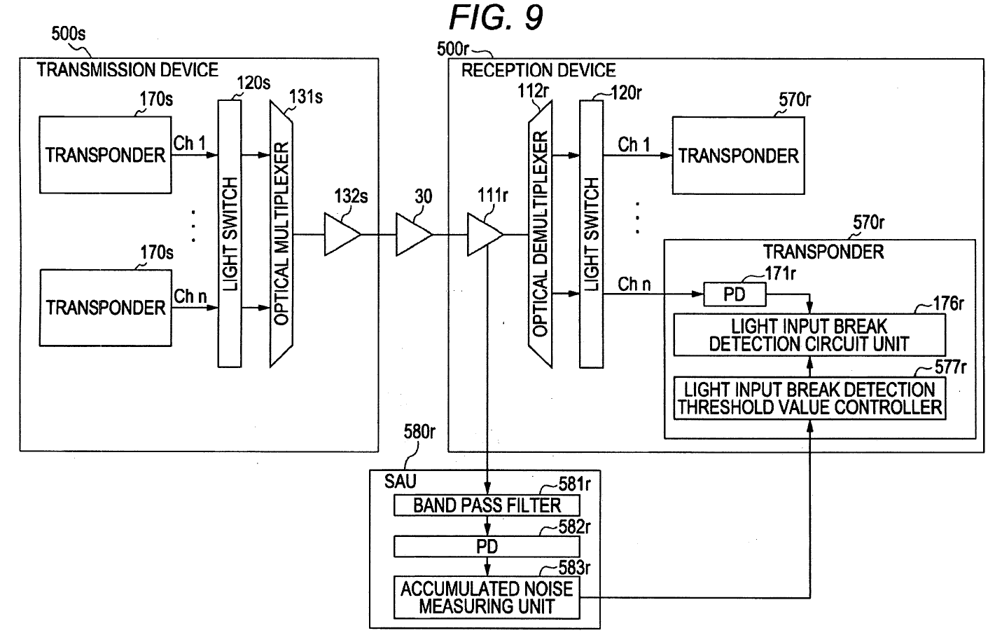

FIG. 9 is a view illustrating a transmission device and the reception device according to Embodiment 5. Note that, to simplify the explanation, only function units that are necessary to explain the feature of Embodiment 5 will be explained here. Also, the function units which achieve the same roles as those of the respective function units shown up to now are denoted by the same reference numerals, and the detailed explanation thereof is omitted.

As shown in FIG. 9, a transmission device 500s and a reception device 500r according to Embodiment 5 are connected to each other through an optical ring network in which an in-line amplifier is disposed. Note that although only one in-line amplifier 30 is shown here, a plurality of in-line amplifiers 30 is disposed in multiple stages on the optical ring network.

The transmission device 500s has a light switch 120s, an optical multiplexer 131s, a post amplifier 132s, and transponders 170s disposed to respective wavelengths (Ch 1 to Ch n). In contrast, the reception device 500r has a preamplifier 111r, an optical demultiplexer 112r, a light switch 120r, and transponders 570r disposed to the respective wavelengths (Ch 1 to Ch n), and an SAU 580r.

Furthermore, each of the transponders 170s of the transmission device 500s has a light emission controller 174s (not shown), and each of the transponders 570r of the reception device 500r has a PD 171r, a light input break detection circuit unit 176r, and a light input break detection threshold value controller 577r.

Here, the optical signal is input from the transponders 170s of the transmission device 500s, sequentially passes through the light switch 120s, the optical multiplexer 131s, and the post amplifier 132s, is transmitted through the in-line amplifier 30, sequentially passes through the preamplifier 111r, the optical demultiplexer 112r, and the light switch 120r in the reception device 500r, and is input to the transponders 570r.

The SAU 580r of the reception device 500r is a processing unit which is connected to the preamplifier 111r and measures the spectral waveform of light input from the operation route and a redundant route in a unit of wavelength and has a band-pass filter unit 581r, a PD 582r, and an accumulated noise measuring unit 583r.

The band-pass filter unit 581r is a processing unit for cutting the band, in which the optical signal is included, from the band of light input from the preamplifier 111r (light input from the operation route). Specifically, the band-pass filter unit 581r cuts the band, in which the optical signal is included, from the band of the light input from the preamplifier 111r using a given band-pass filter (refer to FIG. 5), and inputs the light to the PD 582r.

The PD 582r is a semiconductor device for detecting light input by the band-pass filter unit 581r. Since the light input to the PD 582r is the light from which the band of the optical signal is already cut by the band-pass filter unit 581r, the PD 582r detects the light that includes only accumulated noise.

The accumulated noise measuring unit 583r is a processing unit for measuring the light level of the light detected by the PD 582r and reporting the measured light level to the light input break detection threshold value controller 577r. Since the light detected by the PD 582r is the light that includes only the accumulated noise, the light level reported by the accumulated noise measuring unit 583r is the light level of only the accumulated noise from which the light level of the optical signal is removed.

The light input break detection threshold value controller 577r is a processing unit for setting the light level of accumulated noise as the light input break detection threshold value. Specifically, the light input break detection threshold value controller 577r sets the light level of the accumulated noise reported by the accumulated noise measuring unit 583r as the light input break detection threshold value which serves as a reference of a light input break performed by the light input break detection circuit unit 176r.

As described above, in the reception device 500r of Embodiment 5, the band-pass filter unit 581r cuts the band, in which the optical signal is included, from the band of the light input from the operation route, the accumulated noise measuring unit 583r measures the light level of only the accumulated noise from which the band of the optical signal is cut by the band-pass filter unit 581r, and the light input break detection threshold value controller 577r sets the light level measured by the accumulated noise measuring unit 583r as the light input break detection threshold value. As a result, a proper light input break detection threshold value can be automatically set according to the accumulated amount of ASE noise. Furthermore, a proper light input break detection threshold value can be set effectively by making use of the SAU which already has a function of measuring the light level as well as using an existing band-pass filter and the like.

### Embodiment 6

Next, Embodiment 6 will be explained. In Embodiment 6, a reception device totals the number of stages of light amplifiers disposed in an operation route, calculates the light level of only accumulated noise based on the total number of stages of the light amplifiers, and sets the calculated light level as a light input break detection threshold value.

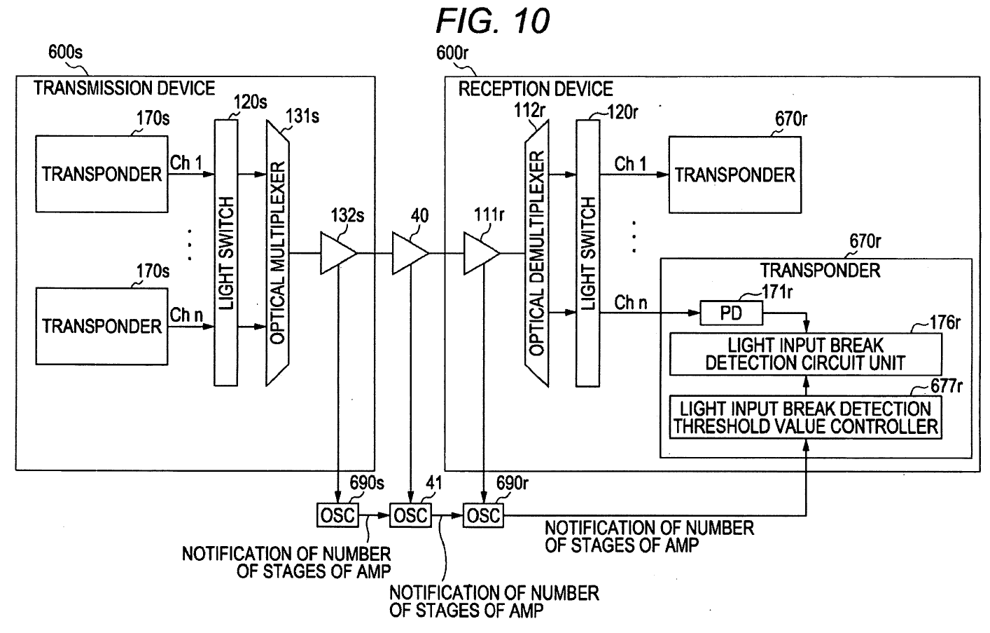

FIG. 10 is a view illustrating a transmission device and the reception device according to Embodiment 6. Note that, to simplify the explanation, only function units that are necessary to explain the feature of Embodiment 6 will be explained here. Also, the function units which achieve the same roles as those of the respective function units shown up to now are denoted by the same reference numerals, and the detailed explanation thereof is omitted.

As shown in FIG. 10, a transmission device 600s and a reception device 600r according to Embodiment 6 are connected to each other through an optical ring network in which an in-line amplifier is disposed. Note that although only one in-line amplifier 40 is illustrated here, a plurality of in-line amplifiers 40 is actually disposed in multiple stages on the optical ring network.

The transmission device 600s has a light switch 120s, an optical multiplexer 131s, a post amplifier 132s, transponders 170s disposed to respective wavelengths (Ch 1 to Ch n), and an OSC 690s. In contrast, the reception device 600r has a preamplifier 111r, an optical demultiplexer 112r, a light switch 120r, transponders 670r disposed to the respective wavelengths (Ch 1 to Ch n), and an OSC 690r. Furthermore, the in-line amplifier 40 has an OSC 41.

Furthermore, each of the transponders 670r of the reception device 600r has a PD 171r, a light input break detection circuit unit 176r, and a light input break detection threshold value controller 677r.

Here, an optical signal is input from the transponders 170s of the reception device 600r, sequentially passes through the light switch 120s, the optical multiplexer 131s, and the post amplifier 132s, is transmitted through the in-line amplifier 40, sequentially passes through the preamplifier 111r, the optical demultiplexer 112r, and the light switch 120r in the reception device 600r, and is input to the transponders 670r.

The OSC 690s of the transmission device 600s is a processing unit for monitoring the input and output of light passing through the post amplifier 132s. The OSC 690s adds “1” to the total number of stages of the amplifiers (post amplifier, preamplifier, in-line amplifier, and the like) sequentially transmitted from an OSC located upstream to an OSC located downstream in the operation route and transmits the resultant number thereof to the OSC 41 of the in-line amplifier 40.

The OSC 41 of the in-line amplifier 40 is a processing unit for monitoring the input and output of the light passing through the in-line amplifier 40. The OSC 41 sequentially adds “1” to the total number of stages of the amplifiers transmitted from the OSC 690s of the transmission device 600s and transmits the resultant number thereof to the OSC 690r of the reception device 600r. Since the plurality of in-line amplifiers 40 is actually disposed in multiple stages, the number of stages of the disposed in-line amplifiers 40 is totaled here.

The OSC 690r of the reception device 600r is a processing unit for monitoring the input and output of light passing through the preamplifier 111r. When the total number of stages of the amplifiers is transmitted from the OSC 41 of the in-line amplifier 40, the OSC 690r reports the total number of stages of the amplifiers to the light input break detection threshold value controller 677r to be described below.

The light input break detection threshold value controller 677r is a processing unit for setting the light level of only the accumulated noise as the light input break detection threshold value. Specifically, the light input break detection threshold value controller 677r calculates the light level of only the accumulated noise based on the total number of stages of the amplifiers reported by the OSC 690r. Here, the light input break detection threshold value controller 677r calculates the light level of the accumulated noise by multiplying, for example, the designed value of ASE noise per stage of the amplifier by the number of stages of the amplifiers.

The light input break detection threshold value controller 677r sets the calculated light level as the light input break detection threshold value which serves as a reference of a light input break performed by the light input break detection circuit unit 176r.

As described above, in the reception device 600r of Embodiment 6, the OSC 690r totals the number of stages of the amplifiers disposed in the operation route, and the light input break detection threshold value controller 677r calculates the light level of only the accumulated noise based on the total number of stages of the amplifiers totaled by the OSC 690r and sets the calculated light level as the light input break detection threshold value. As a result, a proper light input break detection threshold value can be automatically set according to the accumulated amount of the ASE noise. Furthermore, a proper light input break detection threshold value can be automatically set according to the number of stages of the light amplifier making use of the OSC which already has a function of transmitting monitored information.

### Embodiment 7

Next, Embodiment 7 will be explained. Like Embodiment 6, a reception device of Embodiment 7 totals the number of stages of light amplifiers disposed in an operation route, calculates the light level of only accumulated noise based on the total number of stages of the light amplifiers, and sets the calculated light level as a light input break detection threshold value. However, Embodiment 7 is different from Embodiment 6 in that an OSC calculates the light level.

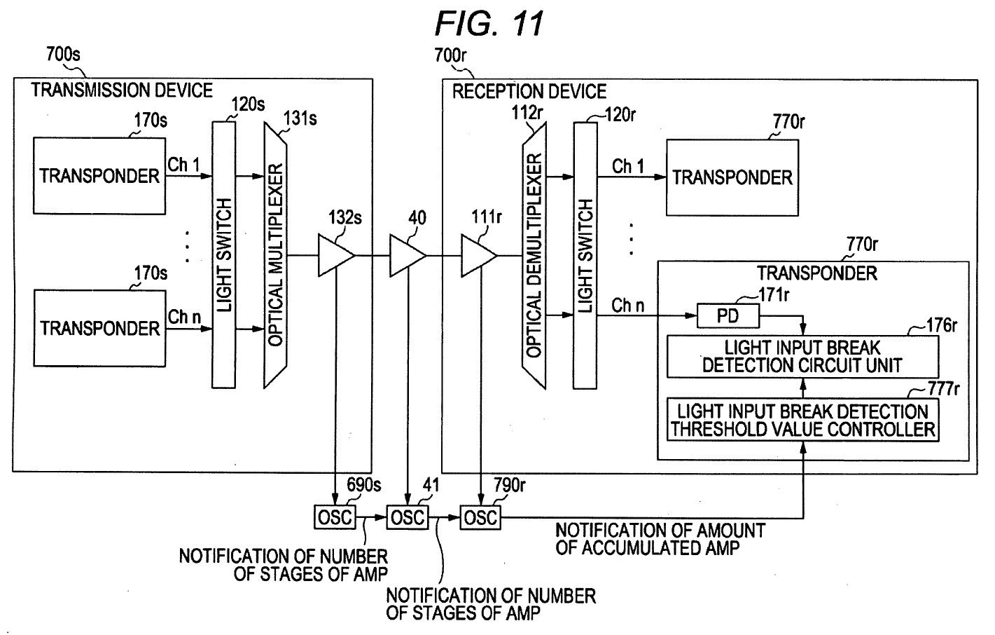

FIG. 11 is a view illustrating a transmission device and the reception device according to Embodiment 7. Note that, to simplify the explanation, only the function units that are necessary to explain the feature of Embodiment 7 will be explained here. Also the function units that achieve the same roles as those of the respective function units described above are denoted by the same reference numerals, and the detailed explanation thereof is omitted.

As shown in FIG. 11, a transmission device 700s and a reception device 700r according to Embodiment 7 are connected to each other through an optical ring network in which an in-line amplifier is disposed. Note that although only one in-line amplifier 40 is shown here, a plurality of in-line amplifiers 40 is disposed in multiple stages on the optical ring network.

The transmission device 700s has a light switch 120s, an optical multiplexer 131s, a post amplifier 132s, transponders 170s disposed to respective wavelengths (Ch 1 to Ch n), and an OSC 690s. In contrast, the reception device 700r has a preamplifier 111r, an optical demultiplexer 112r, a light switch 120r, transponders 770r disposed to the respective wavelengths (Ch 1 to Ch n), and an OSC 790r. Furthermore, the in-line amplifier 40 has an OSC 41.

Furthermore, each of the transponders 770s of the reception device 700r has a PD 171r, a light input break detection circuit unit 176r, and a light input break detection threshold value controller 777r.

Here, an optical signal is input from the transponder 170s of the transmission device 700s, sequentially passes through the light switch 120s, the optical multiplexer 131s, and the post amplifier 132s, is transmitted through the in-line amplifier 40, sequentially passes through the preamplifier 111r, the optical demultiplexer 112r, and the light switch 120r in the reception device 700r, and is input to the transponders 770r.

The OSC 790r of the reception device 700r is a processing unit for monitoring the input and output of light passing through the preamplifier 111r. When the total number of stages of the amplifiers is transmitted from the OSC 41 of the in-line amplifier 40, the OSC 790r calculates the light level of only the accumulated noise based on the total number of stages. Here, the OSC 790r calculates the light level of only the accumulated noise by multiplying, for example, the design value of ASE noise per stage of the amplifier by the number of stages of the amplifiers. Then, the OSC 790r reports the calculated light level to the light input break detection threshold value controller 777r to be described below.

The light input break detection threshold value controller 777r is a processing unit for setting the light level of the accumulated noise as the light input break detection threshold value. Specifically, the light input break detection threshold value controller 777r sets the light level of the accumulated noise reported by the OSC 790r as the light input break detection threshold value which serves as a reference of a light input break performed by the light input break detection circuit unit 176r.

As described above, in the reception device 700r of Embodiment 7, the OSC 790r totals the number of stages of the amplifiers disposed in the operation route and calculates the light level of only the accumulated noise based on the total number of stages of the amplifiers, and the light input break detection threshold value controller 777r sets the light level calculated by the OSC 790r as the light input break detection threshold value. As a result, a proper light input break detection threshold value can be automatically set according to the accumulated amount of the ASE noise. Furthermore, a proper light input break detection threshold value can be automatically set easily according to the number of stages of the light amplifiers while making use of the OSC, which already has a function of transmitting monitored information, and suppressing the amount of improvement of the processing units as to reception of light.

### Embodiment 8

Next, Embodiment 8 will be explained. In Embodiment 8, a reception device totals the light levels of noise actually generated in the respective light amplifiers disposed in an operation route in multiple stages and sets the total light level as a light input break detection threshold value.

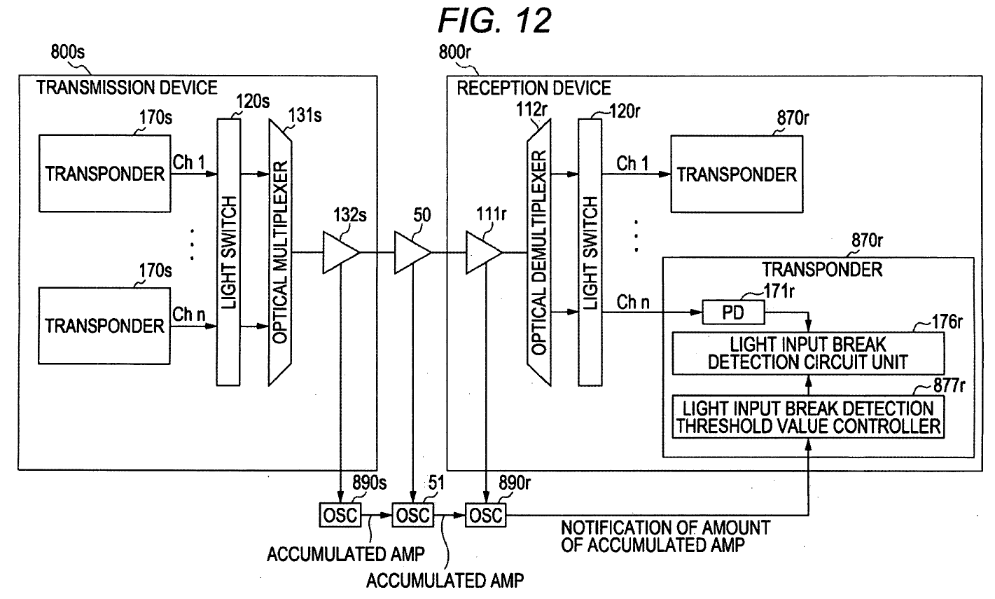

FIG. 12 is a view illustrating a transmission device and the reception device according to Embodiment 8. Note that, to simplify the explanation, only function units that are necessary to explain the feature of Embodiment 8 will be explained here. Also, the function units that achieve the same roles as those of the respective function units shown up to now are denoted by the same reference numerals, and the detailed explanation thereof is omitted.

As shown in FIG. 12, a transmission device 800s and a reception device 800r according to Embodiment 8 are connected to each other through an optical ring network in which an in-line amplifier is disposed. Note that although only one in-line amplifier 50 is shown here, a plurality of in-line amplifiers 50 is disposed in multiple stages on the optical ring network.

The transmission device 800s has a light switch 120s, an optical multiplexer 131s, a post amplifier 132s, transponders 170s disposed to respective wavelengths (Ch 1 to Ch n), and an OSC 890s. In contrast, the reception device 800r has a preamplifier 111r, an optical demultiplexer 112r, a light switch 120r, transponders 870r disposed to the respective wavelengths (Ch 1 to Ch n), and an OSC 890r. Furthermore, the in-line amplifier 50 has an OSC 51.

Furthermore, each of the transponders 870s of the reception device 700r has a PD 171r, a light input break detection circuit unit 176r, and a light input break detection threshold value controller 877r.

Here, an optical signal is input from the transponder 170s of the transmission device 800s, sequentially passes through the light switch 120s, the optical multiplexer 131s, and the post amplifier 132s, is transmitted through the in-line amplifier 50, sequentially passes through the preamplifier 111r, the optical demultiplexer 112r, and the light switch 120r in the reception device 800r, and is input to the transponders 870r.

The OSC 890s of the transmission device 800s is a processing unit for monitoring the input and output of light passing through the post amplifier 132s. The OSC 890s calculates the light level of ASE noise actually generated by the post amplifier 132s, adds the calculated light level to the total light level of the ASE noise, which is sequentially transmitted from an OSC located upstream to an OSC located downstream on the upstream side of the operation route, and transmits the resultant light level to the OSC 51 of the in-line amplifier 50.

The OSC 51 of the in-line amplifier 50 is a processing unit for monitoring the input and output of light passing through the in-line amplifier 50. The OSC 51 calculates the light level of ASE noise actually generated by the in-line amplifier 50, sequentially adds the calculated light level to the total light level of the ASE noise transmitted from the OSC 890s of the transmission device 800s, and transmits the resultant light level to the OSC 890r of the reception device 800r. Since the plurality of in-line amplifiers 50 is actually disposed in multiple stages, the light levels of the number of stages of the in-line amplifiers 50 are totaled here.

The OSC 890r of the reception device 800r is a processing unit for monitoring the input and output of light passing through the preamplifier 111r. When the total light level of the ASE noise is transmitted from the OSC 51 of the in-line amplifier 50, the OSC 890r calculates the light level of the ASE noise actually generated by the preamplifier 111r, adds the calculated light level to the total light level of the ASE noise transmitted from the OSC 51, and reports the resultant light level to the light input break detection threshold value controller 877r to be described below.

The light input break detection threshold value controller 877r is a processing unit for setting the light level of accumulated noise as the light input break detection threshold value. Specifically, the light input break detection threshold value controller 877r sets the total light level of the ASE noise reported by the OSC 890r as the light input break detection threshold value which serves as a reference of a light input break performed by the light input break detection circuit unit 176r.

As described above, in the reception device 800r of Embodiment 8, the OSC 890r totals the light levels of the ASE noise actually generated in the respective amplifiers, and the light input break detection threshold value controller 877r sets the light level totaled by the OSC 890r as the light input break detection threshold value. As a result, a proper light input break detection threshold value can be automatically set according to the accumulated amount of the ASE noise.

Incidentally, in the embodiments 6 and 7 described above, since accumulated ASE noise is calculated simply by multiplying the design value of ASE noise per stage of the amplifier by the number of stages of the amplifiers, a minute difference is caused as compared with the actual accumulated ASE noise. When, for example, it is assumed that the design value of ASE noise per stage of the amplifier is 5 dBm and three stages of the amplifiers are employed, accumulated ASE noise is 5 dBm×three stages=15 dBm.

In contrast, in Embodiment 8, since the accumulated ASE noise that is actually generated by the amplifiers is calculated and set as the light input break detection threshold value, the threshold value can be set more accurately than those of the embodiments 6 and 7.

The embodiments 1 to 8 according to the present invention have been described above. As described above, since, conventionally, the threshold value for detecting a light input break of a reception device is fixed, the light input break may not be performed accurately due to accumulated ASE noise generated by light amplifiers. However, since the threshold value of the light input break detection can be automatically set by employing the present invention, the light input break can be accurately detected regardless of the accumulated ASE noise, thereby providing a light transmission device of high quality.

In any of the above embodiments, since the light input break detection threshold value is set by detecting the accumulated amount of ASE noise of each transponder, a proper input break detection threshold value can be automatically set to each wavelength.

Furthermore, although the WDM transmission device is explained in the above embodiments, a light input break detection threshold value setting program can be obtained by realizing the configuration of the WDM transmission device by software. Thus, a computer for executing the light input break detection threshold value setting program will be explained.

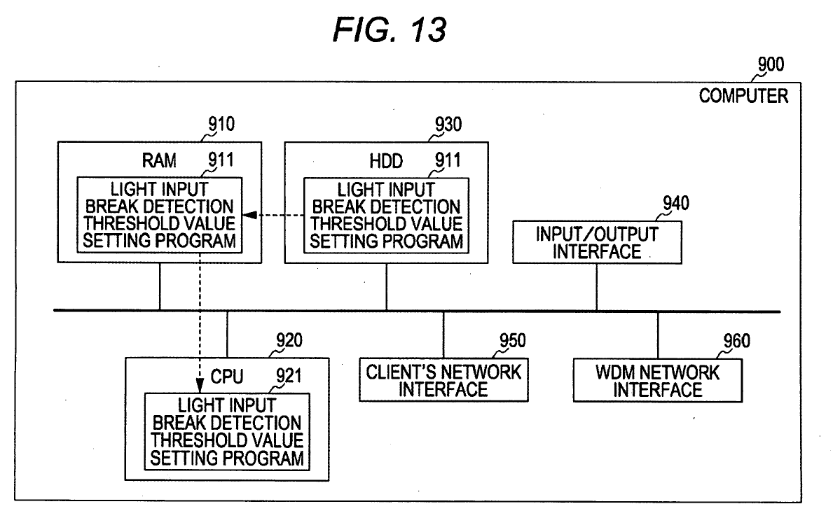

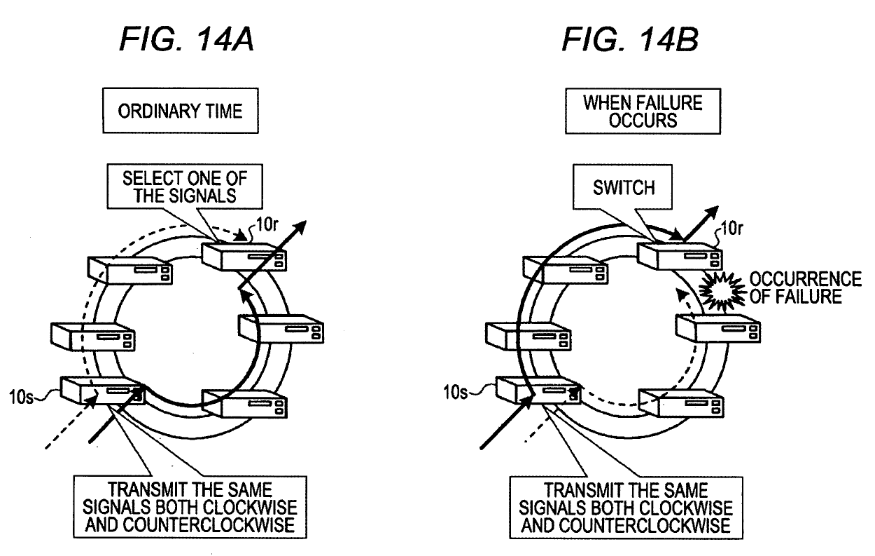

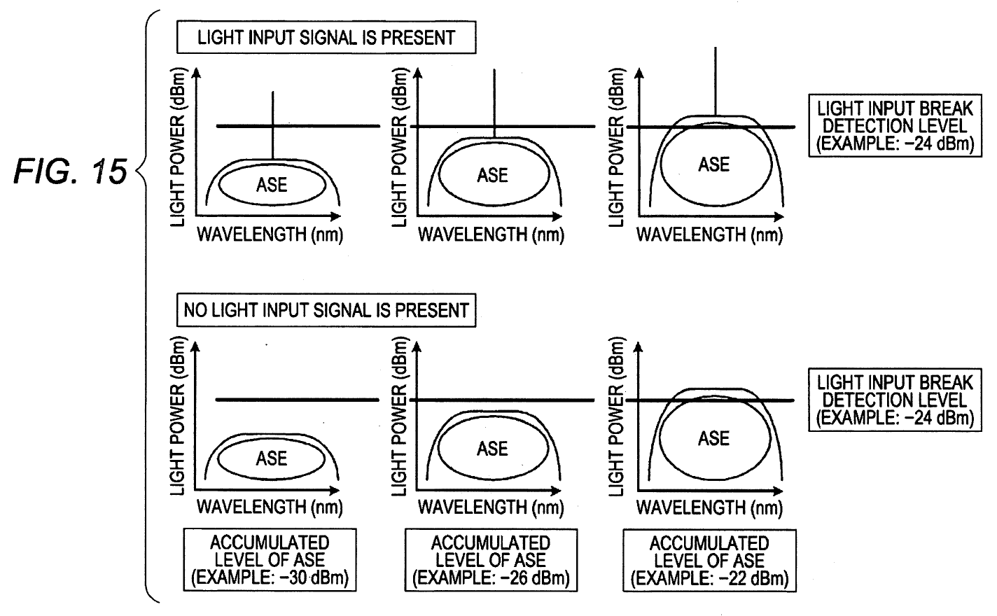

FIG. 13 is a function block diagram illustrating a configuration of the computer for executing the light input break detection threshold value setting program according to the present embodiment. As shown in FIG. 13, the computer 900 has a Random Access Memory (RAM) 910, a Central Processing Unit (CPU) 920, a Hard Disk Drive (HDD) 930, an input/output interface 940, a client network interface 950, and a WDM network interface 960.

The RAM 910 is a memory for storing a program and a result while the program is being executed, and the CPU 920 is a central processing device for reading out the program from the RAM 910 and executing it.

The HDD 930 is a disc device for storing the program and data, and the input/output interface 940 is an interface for connecting an input device such as a mouse, a keyboard, and the like, and a display device.

The client network interface 950 is an interface for connecting the computer 900 to a client's device through a network, and the WDM network interface 960 is an interface for connecting the computer to other WDM transmission devices through the network.

Then, the light input break detection threshold value setting program 911 executed by the computer 900 is stored in a database or the like of the client's device, which is connected to the computer 900 through, for example, the client network interface 950, read out from the database, and installed on the computer 900.

The installed light input break detection threshold value setting program 911 is stored in the HDD 930, read out by the RAM 910, and executed by the CPU 920 as a light input break detection threshold value setting process 921.

Furthermore, the processes, which are described as processes performed automatically, of the respective processes explained in the embodiments may be partly or entirely performed manually, and the processes, which are explained as processes performed manually, may be automatically performed by a known method.

In addition to the above-mentioned, the information, which includes the processing procedures, the control procedures, the specific names, and the various data and parameters, may be arbitrarily changed unless otherwise specified.

Furthermore, since the functions of the respective components of the devices shown in the drawings are conceptual functions, the components need not be arranged as illustrated in the drawings. That is, the specific mode of the respective devices, in which they are separated from each other or integrated with each other, is not limited to that illustrated in the drawings, and the respective devices may be functionally or physically separated or integrated in arbitrary units according to various loads and states of use.

Furthermore, the respective processing functions performed by the respective devices may be partly or entirely realized by a CPU and a program that is analyzed and executed by the CPU, or may be realized as hardware by a wired logic.

As described above, the light transmission device, the light input break detection threshold value setting method, and the light input break detection threshold value setting program according to the present embodiments are useful in an optical ring network in which the OUPSR technology is used and, in particular, suitable for a case where light amplifiers are disposed on a light transmission path in multiple stages.

The turn of the embodiments does not illustrate the superiority and inferiority of the invention. Although the embodiments of the present inventions have been described in detail, it should be understood that the various changes, substitutions, and alterations could be made hereto without depending from the spirit and scope of the invention.

What is claimed is:

1. A light transmission device comprising:
light level measuring means for measuring a light level of light input from a light transmission path of a currently used system;
light input break detection threshold value setting means for detecting only a light level of accumulated noise of the light level measured by the light level measuring means and setting the detected light level as a light input break detection threshold value; and
switching means for switching, when the light level of the light input from the light transmission path of the currently used system becomes substantially equal to or less than the light input break detection threshold value which serves as a reference for detecting a light input break, a light transmission path for receiving an optical signal from the currently used system to a backup system.

2. The light transmission device according to claim 1, further comprising light shutdown notification transmitting means for transmitting a light shutdown notification to a light transmission device of a source connected through the light transmission path of the currently used system to request the light transmission device to stop outputting the optical signal,
wherein, after the light transmission device of the source stops outputting the optical signal in response to the light shutdown notification transmitted by the light shutdown notification means, the light input break detection threshold value setting means sets the light level measured by the light level measuring means as the light input break detection threshold value.

3. The light transmission device according to claim 1, further comprising optical signal band removing means for removing a band, in which the optical signal is included, from the band of the light input from the light transmission path of the currently used system,
wherein the light level measuring means measures the light level of only accumulated noise, from which the band of the optical signal is removed, by the optical signal band removing means, and
the light input break detection threshold value setting means sets the light level measured by the light level measuring means as the light input break detection threshold value.

4. The light transmission device according to claim 1, further comprising:
optical signal to noise ratio calculating means for calculating the optical signal to noise ratio of the light input from the light transmission path of the currently used system; and
accumulated noise level calculating means for calculating the light level of only the accumulated noise based on the optical signal to noise ratio measured by the optical signal to noise ratio measuring means,
wherein the light input break detection threshold value setting means sets the light level calculated by the accumulated noise level calculating means as the light input break detection threshold value.

5. The light transmission device according to claim 1, further comprising:
number of stage of light amplifier calculating means for calculating the number of stages of light amplifiers disposed in the light transmission path of the currently used system; and
accumulated noise level calculating means for calculating the light level of only the accumulated noise based on the number of stages of the light amplifiers calculated by the number of stage of light amplifier calculating means,
wherein the light input break detection threshold value setting means sets the light level calculated by the accumulated noise level calculating means as the light input break detection threshold value.

6. A method of setting a light input break detection threshold value applied to a light transmission device, comprising:
a light level measuring step of measuring a light level of light input from a light transmission path of a currently used system; and
a light input break detection threshold value setting step of detecting only the light level of accumulated noise of the light level measured by the light level measuring step and setting the detected light level as a light input break detection threshold value which serves as a reference for detecting the detected light level as a light input break.
